(19) United States
(12) Patent Application Publication
(10) Pub. No.: US 2011/0179174 A1
(43) Pub. Date: Jul. 21, 2011

(54) APPARATUS IDENTIFICATION IN COEXISTENCE NETWORKING

(75) Inventors: Mika KASSLIN, Espoo (FI); Jari Junell, Espoo (FI); Juha Salokannel, Tampere (FI)

(73) Assignee: Nokia Corporation, Espoo (FI)

(21) Appl. No.: 12/689,663

(22) Filed: Jan. 19, 2010

(51) Int. Cl. G06F 15/173

(52) U.S. Cl. 709/226

(57) ABSTRACT

A system for managing wireless interaction between apparatuses that may be, for example, masters in various coexistent wireless networks. An apparatus may transmit a request to a server via an Internet connection. This request may inquire as to whether other apparatuses are located proximate to the apparatus in an operational environment. The server may return information to the apparatus via the Internet informing the apparatus of other proximately-located apparatuses. The apparatus may utilize this information to communicate with the proximate apparatuses in order to coordinate collaborative operations.

### BACKGROUND

1. Field of Invention

The present invention relates to wireless communication, and in particular, to managing wireless radio operation in apparatuses that are interacting in wireless networks.

2. Background

Advancements in communication-related technology have helped to proliferate the integration of communication-related functionality in everyday applications. In particular, some ability to interact electronically using wired and/or wireless communication is now expected for many existing and emerging applications. Where wireless communication is being employed, wireless transports may be utilized to send electronic data to multiple destinations. These destinations may reside in different locations, and thus, more than one wireless transport may be employed in a single apparatus in order to address these communication needs. Further, the suppliers and consumers of electronic information may not operate using the same forms of communication, so these apparatuses must be able to change communication configuration in order to support less-flexible applications (e.g., processing, size or power limited apparatuses).

However, while enhanced functionality may be realized through the proliferation of wireless communication, the increasing inclusion of wireless support in different applications will unavoidably result in increased wireless signal traffic. As wireless protocols may operate in the same or similar bandwidths, interference may occur when the protocols operate concurrently. This would especially be the case when transmitters and/or receivers are in close proximity, such as in an apparatus that supports multiple protocols. Moreover, other sources of interference may exist within an operational environment. For example, electromagnetic fields may be generated by electronic apparatuses or power systems. Further, legacy wireless communication signals, such as AM/FM radio and television (TV) broadcast signals, may operate in frequency bands that fall very close to emerging wireless protocols, which may also cause signal interference.

Legacy broadcast signals may be especially problematic when attempting to reuse bandwidth that was traditionally reserved for AM/FM radio and/or TV broadcasts. For example, in the U.S. the Federal Communication Commission (FCC) has decided that TV white space, or the operational frequencies that were previously reserved for TV channels that is not currently in use, is available for unlicensed broadband use. However, operating in these sections of unused TV broadcast spectrum may entail certain requirements and/or impediments. More specifically, in addition to rules prohibiting interference with certain legacy apparatuses that operate within this spectrum, the unlicensed nature of these unused channels means that many apparatuses may be operating in this bandwidth, resulting in potential interference coming from many sources.

In order to support wireless network operation in view of such regulations and/or obstacles, the wireless industry has began to discuss how to standardize operations for wireless apparatuses operate in TV white spaces. For example, standard operation may require networks in this environment may to interact (e.g., exchange information) in order to avoid interference. However, avoiding interference by facilitating cooperation between apparatuses from a multitude of different manufacturers and owned by different entities may be problematic, to say the least.

### SUMMARY

Various example embodiments of the present invention may be directed to a method, apparatus, computer program product and system for managing wireless interaction between apparatuses that may be, for example, masters in various coexistent wireless networks. An apparatus may transmit a request to a server via an Internet connection. This request may inquire as to whether other apparatuses are located proximate to the apparatus in an operational environment. The server may return information to the apparatus via the Internet informing the apparatus of other proximately-located apparatuses. The apparatus may utilize this information to communicate with the proximate apparatuses in order to coordinate collaborative operations.

In at least one example implementation the information provided by the server to the apparatus may comprise Internet addresses corresponding to potential network masters that are managing wireless networks in the same operational environment as the apparatus, which is also a network master. The apparatus may contact at least some of the potential apparatuses via the Internet in order to request communication configuration and test information. The other apparatuses may respond to these requests, and the apparatus may use the communication received configuration and test information to select a group of candidate apparatuses. Candidate apparatuses may be selected based on, for example, the distance from the apparatus to a potential apparatus, transmission properties (e.g., transmission power of potential apparatuses), etc. Information needed for candidate selection may be provided by potential apparatuses to the apparatus via an Internet connection.

In accordance with at least one example embodiment of the present invention, the apparatus may then initiate testing the group of candidate apparatuses. Testing may comprise transmitting one or more wireless signals that should be receivable by the candidate apparatuses. The candidate apparatuses that receive the wireless signals may then transmit reporting to the apparatus via an Internet connection confirming receipt of a signal. The apparatus may utilize testing results to select real neighbor apparatuses from the group of candidate apparatuses. The apparatus may then engage in further communication with apparatuses in the group of real neighbor apparatuses towards the goal of collaboration. For example, this communication may take the form of direct wireless interaction between these apparatuses to avoid interference.

The foregoing summary includes example embodiments of the present invention that are not intended to be limiting. The above embodiments are used merely to explain selected aspects or steps that may be utilized in implementations of the present invention. However, it is readily apparent that one or more aspects, or steps, pertaining to an example embodiment can be combined with one or more aspects, or steps, of other embodiments to create new embodiments still within the scope of the present invention. Therefore, persons of ordinary skill in the art would appreciate that various embodiments of the present invention may incorporate aspects from other embodiments, or may be implemented in combination with other embodiments.

### DESCRIPTION OF DRAWINGS

The invention will be further understood from the following description of various example embodiments, taken in conjunction with appended drawings, in which:

FIG. 1 discloses example apparatuses, communication configuration and network architecture usable in implementing at least one embodiment of the present invention.

FIG. 2 discloses additional detail with respect to example communication interfaces that may be usable with various embodiments of the present invention.

FIG. 3 discloses an example of an operational environment in which at least one embodiment of the present invention may be implemented.

FIG. 4A discloses further detail regarding the example operational environment that was initially disclosed in FIG. 3.

FIG. 4B discloses examples of other potential signal sources that may exist in the example operational environment that was initially disclosed in FIG. 3.

FIG. 5 discloses an example first stage interaction between an apparatus and a server in accordance with at least one embodiment of the present invention.

FIG. 6 discloses an example second stage interaction between an apparatus and potential apparatuses in accordance with at least one embodiment of the present invention.

FIG. 7 discloses an example third stage interaction between an apparatus and candidate apparatuses in accordance with at least one embodiment of the present invention.

FIG. 8 discloses an example fourth stage interaction between an apparatus and real neighbor apparatuses in accordance with at least one embodiment of the present invention.

FIG. 9 discloses an example of apparatus collaboration in accordance with at least one embodiment of the present invention.

FIG. 10 discloses a flowchart for an example apparatus discovery and interaction process in accordance with at least one embodiment of the present invention.

### DESCRIPTION OF EXAMPLE EMBODIMENTS

While the invention has been described below in terms of a multitude of example embodiments, various changes can be made therein without departing from the spirit and scope of the invention, as described in the appended claims.

### I. Example System with which Embodiments of the Present Invention may be Implemented

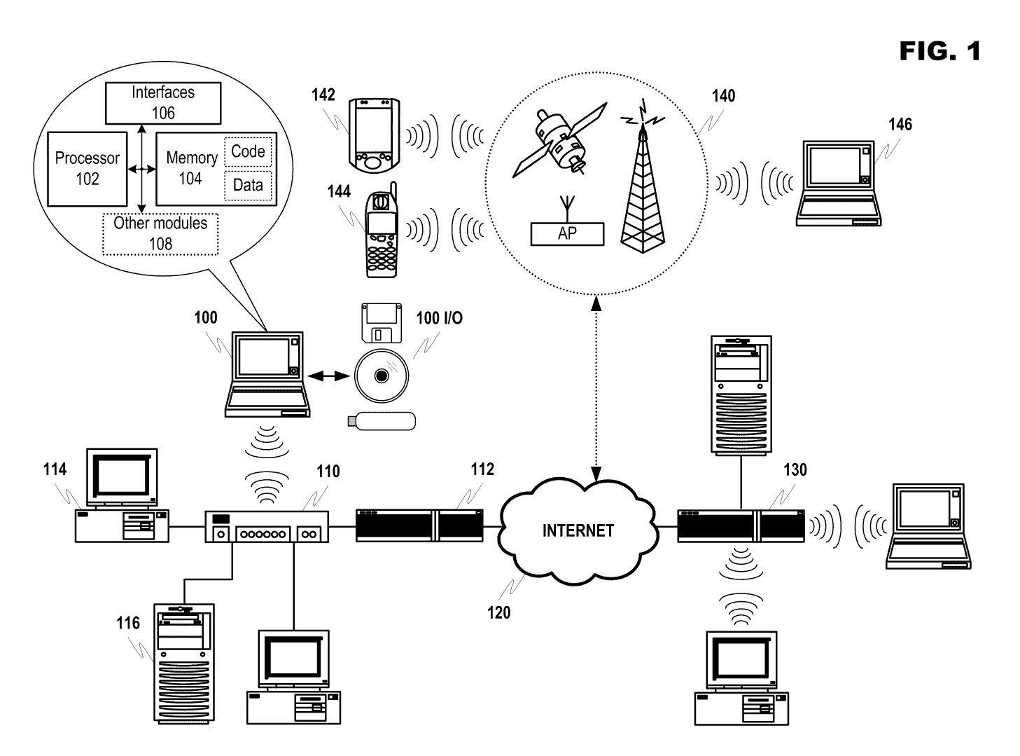

An example of a system that is usable for implementing various embodiments of the present invention is disclosed in FIG. 1. The system comprises elements that may be included in, or omitted from, configurations depending, for example, on the requirements of a particular application, and therefore, is not intended to limit present invention in any manner.

Computing device 100 may correspond to various processing-enabled apparatuses including, but not limited to, micro personal computers (UMPC), netbooks, laptop computers, desktop computers, engineering workstations, personal digital assistants (PDA), computerized watches, wired or wireless terminals/nodes/etc., mobile handsets, set-top boxes, personal video recorders (PVR), automatic teller machines (ATM), game consoles, or the like. Elements that represent basic example components comprising functional elements in computing device 100 are disclosed at 102-108. Processor 102 may include one or more devices configured to execute instructions. In at least one scenario, the execution of program code (e.g., groups of computer-executable instructions stored in a memory) by processor 102 may cause computing device 100 to perform processes including, for example, method steps that may result in data, events or other output activities. Processor 102 may be a dedicated (e.g., monolithic) microprocessor device, or may be part of a composite device such as an ASIC, gate array, multi-chip module (MCM), etc.

Processor 102 may be electronically coupled to other functional components in computing device 100 via a wired or wireless bus. For example, processor 102 may access memory 102 in order to obtain stored information (e.g., program code, data, etc.) for use during processing. Memory 104 may generally include removable or imbedded memories that operate in a static or dynamic mode. Further, memory 104 may include read only memories (ROM), random access memories (RAM), and rewritable memories such as Flash, EPROM, etc. Examples of removable storage media based on magnetic, electronic and/or optical technologies are shown at 100 I/O in FIG. 1, and may serve, for instance, as a data input/output means. Code may include any interpreted or compiled computer language including computer-executable instructions. The code and/or data may be used to create software modules such as operating systems, communication utilities, user interfaces, more specialized program modules, etc.

One or more interfaces 106 may also be coupled to various components in computing device 100. These interfaces may allow for inter-apparatus communication (e.g., a software or protocol interface), apparatus-to-apparatus communication (e.g., a wired or wireless communication interface) and even apparatus to user communication (e.g., a user interface). These interfaces allow components within computing device 100, other apparatuses and users to interact with computing device 100. Further, interfaces 106 may communicate machine-readable data, such as electronic, magnetic or optical signals embodied on a computer readable medium, or may translate the actions of users into activity that may be understood by computing device 100 (e.g., typing on a keyboard, speaking into the receiver of a cellular handset, touching an icon on a touch screen device, etc.) Interfaces 106 may further allow processor 102 and/or memory 104 to interact with other modules 108. For example, other modules 108 may comprise one or more components supporting more specialized functionality provided by computing device 100.

Computing device 100 may interact with other apparatuses via various networks as further shown in FIG. 1. For example, hub 110 may provide wired and/or wireless support to devices such as computer 114 and server 116. Hub 110 may be further coupled to router 112 that allows devices on the local area network (LAN) to interact with devices on a wide area network (WAN, such as Internet 120). In such a scenario, another router 130 may transmit information to, and receive information from, router 112 so that devices on each LAN may communicate. Further, all of the components depicted in this example configuration are not necessary for implementation of the present invention. For example, in the LAN serviced by router 130 no additional hub is needed since this functionality may be supported by the router.

Further, interaction with remote devices may be supported by various providers of short and long range wireless communication 140. These providers may use, for example, long range terrestrial-based cellular systems and satellite communication, and/or short-range wireless access points in order to provide a wireless connection to Internet 120. For example, personal digital assistant (PDA) 142 and cellular handset 144 may communicate with computing device 100 via an Internet connection provided by a provider of wireless communication 140. Similar functionality may be included in devices, such as laptop computer 146, in the form of hardware and/or software resources configured to allow short and/or long range wireless communication.

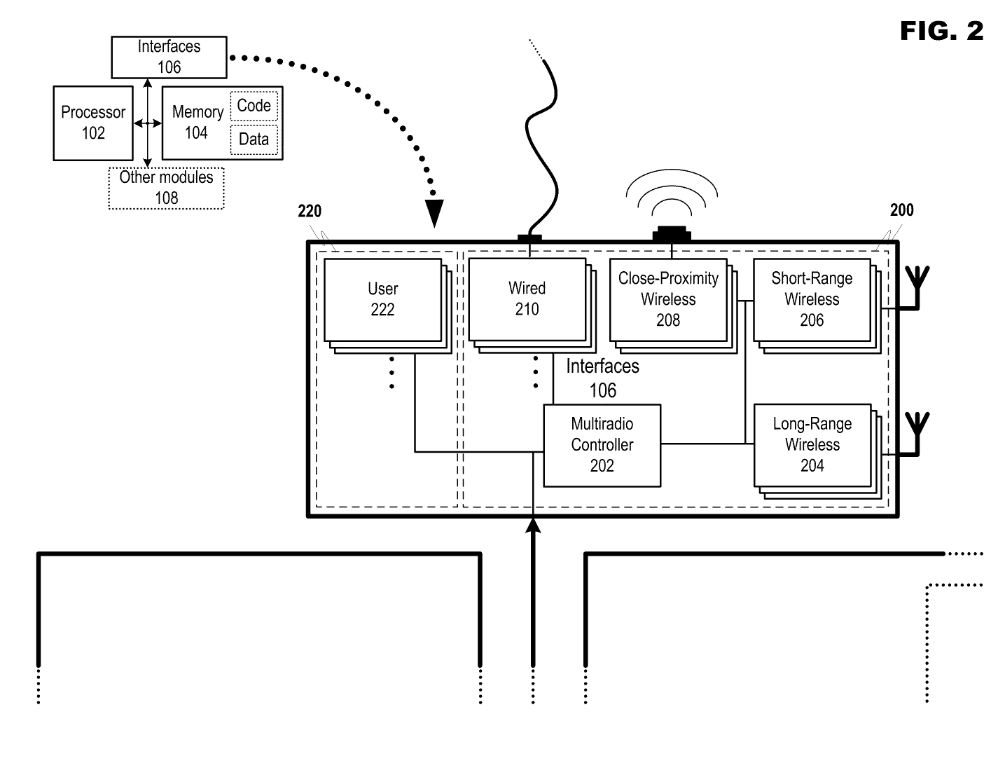

Further detail regarding example interface component 106, shown with respect to computing device 100 in FIG. 1, is now discussed with respect to FIG. 2. Initially, interfaces such as disclosed at 106 are not limited to use only with computing device 100, which is utilized herein only for the sake of explanation. As a result, interface features may be implemented in any of the apparatuses that are disclosed in FIG. 1 (e.g., 142, 144, etc.) As previously set forth, interfaces 106 may include interfaces both for communicating data to computing apparatus 100 (e.g., as identified at 200) and other types of interfaces 220 including, for example, user interface 222. A representative group of apparatus-level interfaces is disclosed at 200. For example, multiradio controller 202 may manage the interoperation of long range wireless interfaces 204 (e.g., cellular voice and data networks), short-range wireless interfaces 206 (e.g., Bluetooth and WLAN networks), close-proximity wireless interfaces 208 (e.g., for interactions where electronic, magnetic, electromagnetic and optical information scanners interpret machine-readable data), wired interfaces 210 (e.g., Ethernet), etc. The example interfaces shown in FIG. 2 have been presented only for the sake of explanation herein, and thus, are not intended to limit the various embodiments of the present invention to utilization of any particular interface. Embodiments of the present invention may also utilize interfaces that are not specifically identified in FIG. 2.

Multiradio controller 202 may manage the operation of some or all of interfaces 204-210. For example, multiradio controller 202 may prevent interfaces that could interfere with each other from operating at the same time by allocating specific time periods during which each interface is permitted to operate. Further, multiradio controller 202 may be able to process environmental information, such as sensed interference in the operational environment, to select an interface that will be more resilient to the interference. These multiradio control scenarios are not meant to encompass an exhaustive list of possible control functionality, but are merely given as examples of how multiradio controller 202 may interact with interfaces 204-210 in FIG. 2.

### II. Example Operational Environment

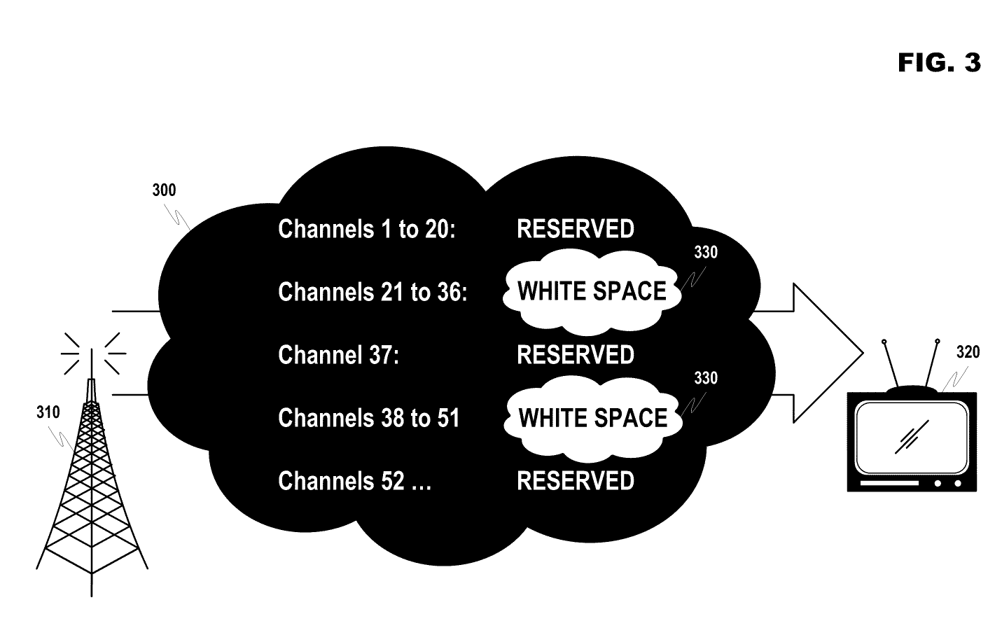

FIG. 3 discloses an example environment that will be utilized for explaining the various embodiments of the present invention. While a TV white space system will be utilized for the sake of example herein, the various example implementations of the present invention that will be disclosed below are not strictly limited only to this operational environment. As a result, various embodiments of the present invention may be applied to different situations that may have somewhat similar characteristics. For instance, such scenarios may include one or more apparatuses interacting wirelessly in an operational environment that is also experiencing substantial signal activity due to other signal sources that are also present in the environment.

FIG. 3 discloses a rudimentary white space system. Initially, bandwidth 300 may be licensed to broadcasters 310. Bandwidth 300 may be separated into channels that are used by broadcasters 310 to send programming to TV 320. For example, each channel may be used by a broadcaster 310 to transmit audio/visual programming to TV 320. However, some of bandwidth 300 that is licensed for TV programming may remain unused (e.g., there is no broadcaster using the channel, other signal sources may create interference within the frequency range that defines a channel, etc.). This unused space is identified in FIG. 3 as white space 330. White space 330 may therefore comprise some licensed bandwidth within bandwidth 300 that may be reallocated. TV white space (TVWS) in the U.S. may comprise TV channels 21-51, 470 MHz to 698 MHz, excluding channel 37. As a result, channels 21 to 36 and/or channels 38 to 51 may be reallocated for other uses. An example use for bandwidth 330 may be for unlicensed short-range wireless communication, allowing close-proximity wireless networks to be formed between apparatuses.

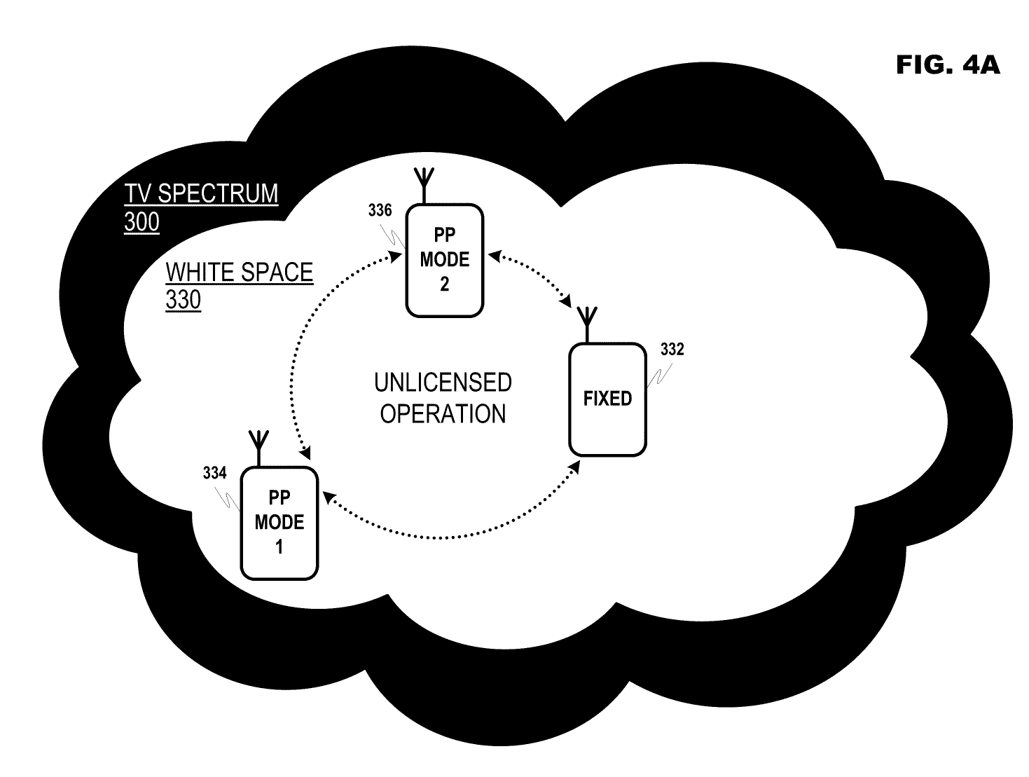

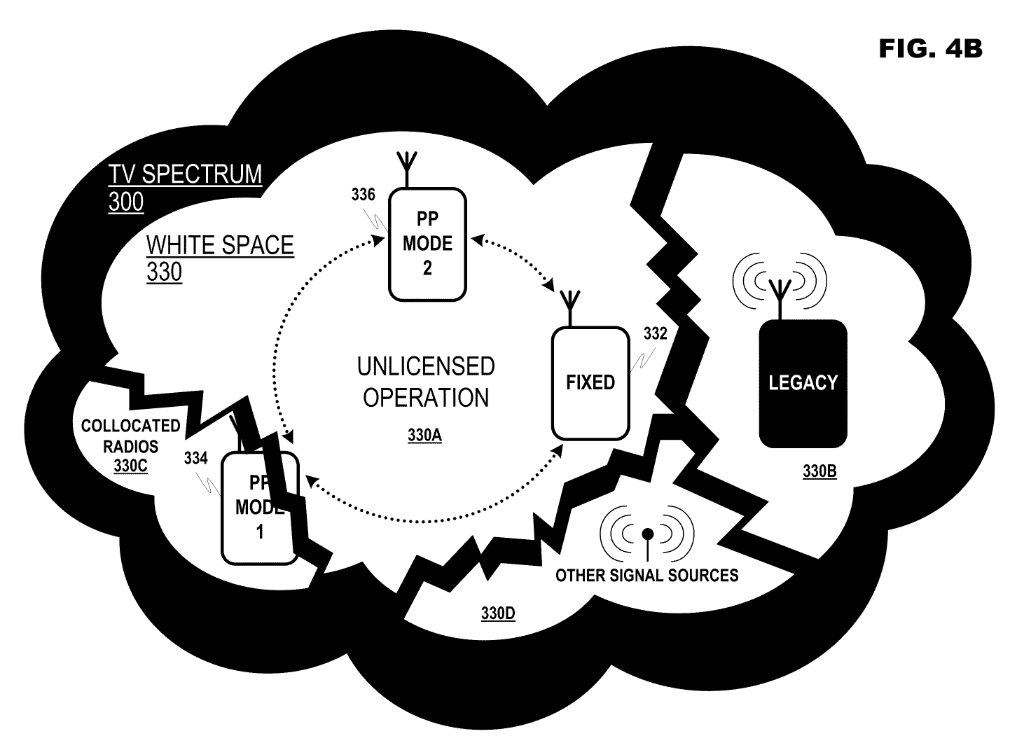

Now referring to FIG. 4A, the example of white space 330 as an environment in which apparatuses may interact is explored further. In TVWS network terminology there may be two categories of apparatus: fixed and personal/portable. Fixed apparatuses 334 are stationary, and thus, have a constant position over time. Personal/portable devices are capable of moving, so their location may vary over time. Furthermore, personal/portable devices are categorized into PP Mode I apparatuses 334 and PP Mode II apparatuses 336. PP Mode II devices 336 can initiate networks (e.g., they can serve as access points in WLAN-type networks) as a master device. PP Mode I devices 334 can only operate as clients of TVWS networks, which may be controlled by either fixed apparatus 332 or PP Mode II device 336. Both fixed apparatuses 332 and personal/portable Mode II devices 336 may utilize spectrum sensing and database access to determine whether or not a channel is occupied by a primary user. In addition, a “special” type of apparatus (not pictured) may also be defined in TVWS networks. Such special apparatuses may be portable and may rely only on spectrum sensing to identify occupied channels.

Ideally, apparatuses 332, 224 and 336, as disclosed FIG. 4, may interact freely via wireless communication as long as they remain within the frequency range established for white space 330. However, in practice white space 330 may not be an ideal operational environment. This concept is discussed further with respect to FIG. 4B. In example scenarios where white space 330 is made available for unlicensed short-range wireless communication, many signal sources may exist within this frequency range, and as a result there may be many opportunities for interference to occur between these various sources. Initially, intra-apparatus interference (e.g., interference in an apparatus caused by other functionality occurring in the same apparatus) may exist. Co-located coexistence interference 330C means that devices may contain multiple radios that concurrently support wireless transports operating in proximate frequency bands. In this instance the multiple radios may cause interference between themselves. This is especially a problem if the apparatus is mobile cellular handset or other small factor device since the physical distance between the antennas is insubstantial (e.g., closer antennas=increased interference) and even the smallest leakage power can result in significant performance degradation. Transmission power level may also be a contributor to intra-apparatus interference, which may differ based on type of radio (e.g., cellular radio ˜2 W is stronger than short-range unlicensed radio ˜100 mW).

The Quality of Service (QoS) delivered by wireless transports may also depend on the sensitivity of the radio technology being employed (e.g., how resistant is the technology to interference). For example, severe co-located interference may occur when a high power radio transmits at the same time when low power radio is receiving. For example, if a device supports both Long Term Evolution (LTE) operating at 700 MHz and TVWS technology using wireless local area network (WLAN) technology where the TVWS channel exists at high end of TV band (e.g., ˜690 MHz), the interference between LTE and TVWS technology can be substantial. The aforementioned case is just an example. Other combinations may also prove problematic. For example, other signal sources 330D may comprise apparatuses whose signals are present within the operational environment but are not part of the short-range unlicensed wireless network formed as disclosed at 330A. Other signal sources 330 may comprise, for example, electronic or electromechanical apparatuses whose operation causes electromagnetic field (EMF) interference in the operational environment. Moreover, wireless-enabled apparatuses that are operating close by but are not participating in unlicensed operation 330A may also contribute to signal traffic.

Such wireless-enabled apparatuses may prove extremely problematic in TVWS network systems since there may be very strict sensing requirements of incumbent users (e.g., legacy users 330B). For example, in TVWS systems a device may be requested to sense if a channel is used by a primary user before initiating any communication in that radio channel. Primary users may include, for example, TV broadcasters and/or a wireless microphones. More specifically, the FCC requires that devices must operate using a −114 dBM detection sensitivity. As a result, any other co-located radio should interfere less than the above value to avoid false positive detections of primary users. Traditionally it would be impossible to achieve this level of sensitivity without implementing application specific co-located coexistence detection. For this reason, TVWS networking may be considered the first practical application of cognitive radio.

### III. Example Apparatus Discovery

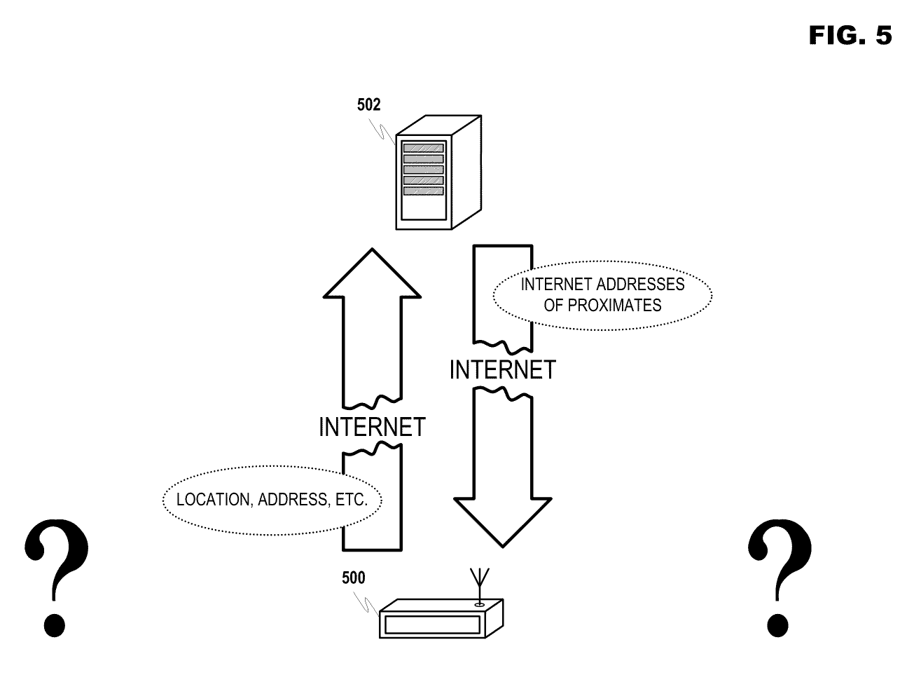

In accordance with at least one embodiment of the present invention, FIGS. 5-9 disclose possible stages in an example process wherein apparatuses may first be discovered (e.g., located and/or identified) before communication between these apparatuses may initiate in order to select apparatuses having certain characteristics. While various embodiments of the present invention will be discussed with respect to managing coexistence in an operational environment, such as in TV white space, through collaboration between wireless network masters, the various embodiments are not strictly limited to this implementation. As a result, the embodiments of the present invention, such as described by example herein, may be implemented in similar scenarios where apparatus operation may be managed in view of environmental requirements/obstacles.

Initially, FIG. 5 discloses an example apparatus 500. In accordance with example described above apparatus 500 may be a master device that manages operation in a short-range wireless network. Moreover, the environment in which apparatus 500 operates may be TV white space, and thus, may have certain operational requirements and/or obstacles. For the purposes of explanation herein it is taken as a given that at least one requirement for apparatuses utilizing this bandwidth is that these apparatuses must be able to collaborate with each other in order to avoid their operation interfering with other coexisting networks. In the FIG. 5 example, apparatus 500 may initiate the process by transmitting information to a predefined entity such as server 502. While an Internet-connected data server 502 is used for the sake of example herein, the various embodiments of the present invention are not limited only to this apparatus. Other apparatuses that are capable of Internet communication may be employed as well. This transmission may take the form of a message sent over a wired or wireless Internet connection. In instances where wireless technology may be employed, the connection to the Internet may be established utilizing short-range or long-range transports that do not operate using TVWS (e.g., a Bluetooth link to an access point, cellular data connections such as UMTS or LTE, etc.). The message may comprise information such as apparatus identification, apparatus Internet address, location (e.g., network membership, cell membership, geographic, etc.) of apparatus 500 or any other information that might be needed in order to determine the environment in which apparatus 500 is operating.

Server 502 may utilize this information to identify other apparatuses operating in proximity to apparatus 500. Proximity may pertain to physical apparatus location or to sources of signals within communication range of apparatus 500. For example, server 502 may maintain a list of registered apparatuses and may query the list to determine the registered apparatuses that are proximate to apparatus 500. For example, registered apparatuses may comprise devices that are capable of creating, initiating and/or forming secondary networks (e.g., fixed 332 or mode II 336 apparatuses in the TVWS spectrum). Server 502 may then respond to apparatus 500 via the same or another Internet connection. The response may identify proximate apparatuses, and in accordance with at least one embodiment of the present invention, may also comprise internet addresses for each proximate apparatus. In some instances the relative or absolute location of each apparatus may also be specified in the response, or the apparatuses may be presented (e.g., listed) in the response in an order based on location, so that apparatus 500 may determine the location of each apparatus with respect to its current location. Using this information, some of the apparatuses identified in the response may be classified as potential apparatuses based on, for example, the proximity of the apparatus with respect to apparatus 500. Potentiality may then rank each apparatus beginning from the closest to apparatus 500. Apparatuses that are located outside of communication range of apparatus 500 may not be considered as a potential apparatus.

### IV. Example Apparatus Interaction

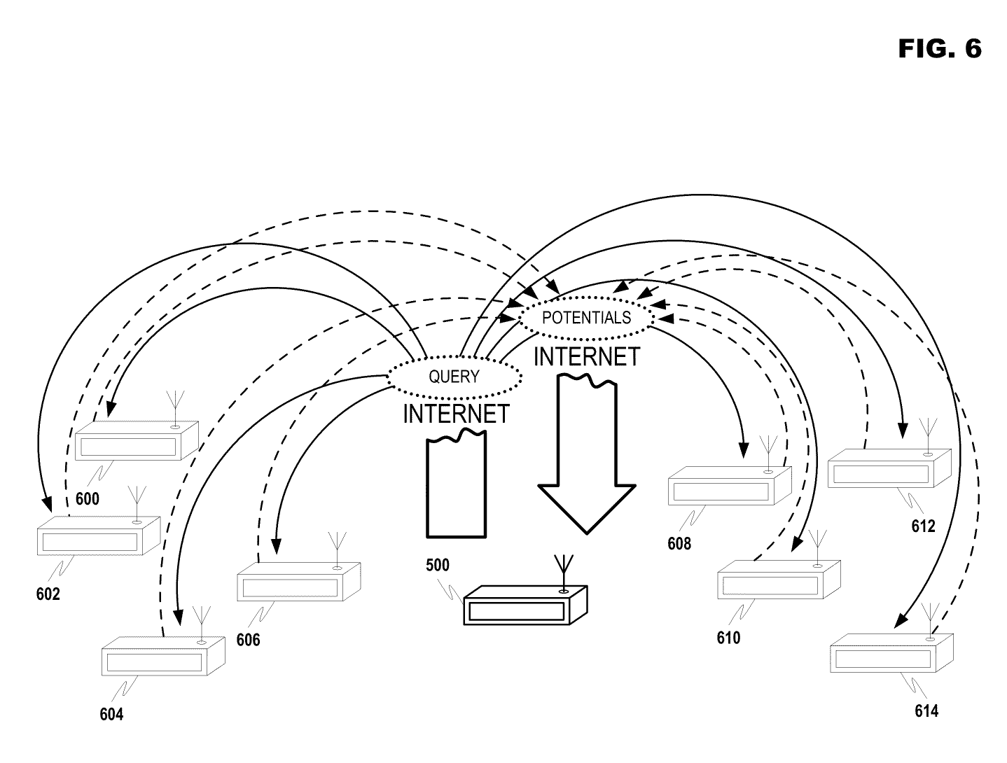

Referring now to FIG. 6, a second stage for the example of FIG. 5 is disclosed. After a response is received from the server, apparatus 500 may again utilize the information in the response (e.g., such as the Internet address information) to contact potential apparatuses 600 to 614. This contact may comprise messages transmitted over the same Internet connection or different connections. For example, Apparatus 500 may send second inquiries to potential apparatuses 600 to 614 requesting location, communication configuration and test information. Location information may provide the absolute or relative location of an apparatus based on network membership, coordinates, distance, etc. Configuration information may comprise apparatus radio parameter information corresponding to each of potential apparatuses 600-614 as identified in the response from server 502. The required radio parameters may include operating channel, channel width, maximum transmission power, etc. Communication test information may comprise at least parameters for test signal transmission. In general, radio parameters are such that they can be used effectively in neighbor qualification that will be described below. As further disclosed in FIG. 6, some or all of the apparatuses 600-614 may respond to the inquiry made by apparatus 500 by providing communication and/or test data via the Internet. Responses may be provided to apparatus 500 via the same Internet connection or different connections.

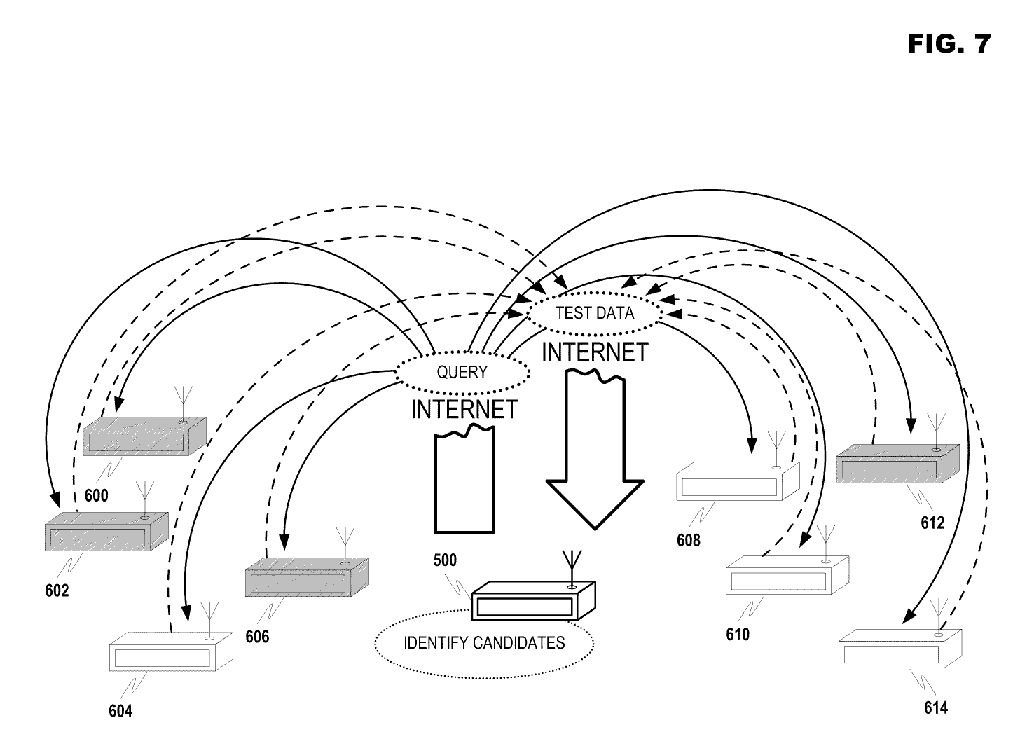

As shown in FIG. 7, apparatus 500 may select one or more candidate apparatuses based on the responses received from potential apparatuses 600 to 614. “Candidate” indicates that, based on the received responses, the previously determined group of potential apparatuses may comprise at least one real neighbor apparatus that may be able to collaborate with apparatus 500 in order to avoid interference between coexisting networks. For example, apparatus 500 may omit from the group of candidate apparatuses any potential apparatus from which a response to the second inquiry is not received. Further, potential apparatuses 600 to 614 that respond to the second inquiry but, for example, are not able to collaborate, are out of communication range of apparatus 500, employ a form of communication that will not interfere with apparatus 500 (e.g., a wireless protocol operating in a different spectrum), etc., may also be omitted from being selected as a candidate apparatus. While this selection process is principally directed to selecting master apparatuses that are candidates to collaborate with each other, it is also possible for non-master network apparatuses to influence selection. For example, in accordance with at least one embodiment of the present invention, if apparatus 500 and apparatus 602, which is also a network master, are not located within interference range of each other, but a node that is a member of a network where apparatus 602 is a master is within interference range of apparatus 500, then master apparatus 602 may be selected as a candidate apparatus. Example omissions are shown in FIG. 7 by potential apparatuses 600 to 614 that are shaded. In particular, only apparatuses 604, 608, 610 and 614 are candidate apparatuses.

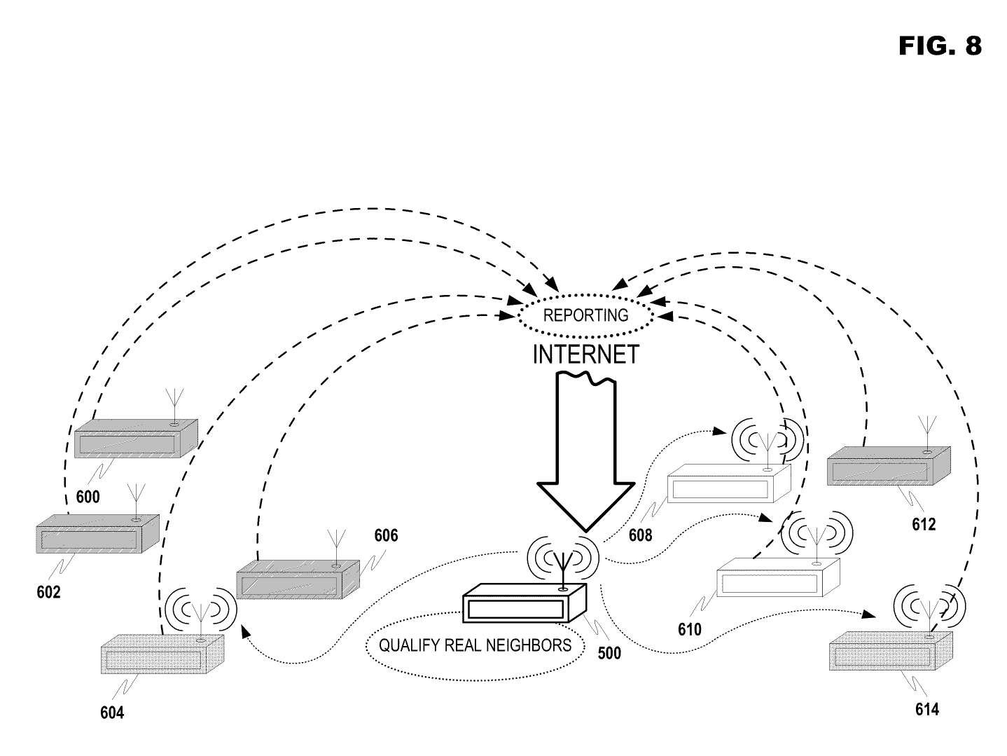

In accordance with various embodiments of the present invention, a further stage of the process is disclosed in FIG. 8. After apparatus 500 has received the requested information from the potential apparatuses and has qualified (e.g., selected) candidate apparatuses from the potential apparatuses, it may then qualify real neighbor apparatuses from amongst the candidate apparatuses by using radio detection of neighbors within interference range. This may happen as follows for each candidate neighbor: apparatus 500 may inform each candidate apparatuses 604, 608, 610 and 614 via the Internet that it will began test signal transmission. The candidate apparatuses may then commence listening for the test signal transmission in order to determine whether they can detect the signal being transmitted from apparatus 500. The test signals transmitted by apparatus 500 may utilize the test signal parameters previously provided by candidate apparatuses 604, 608, 610 and 614.

In some instances the candidate apparatuses may request that the transmission occur during quiet periods in the channel used by the candidate apparatus. As a result, candidate apparatuses 604, 608, 610 and 614 would not have to measure other channels and may continue operation in its own channel and neighbor detection measurements in parallel. The quiet periods need to have some periodicity, which candidate apparatuses may indicate as part of the test signal parameters that were previously provided. Apparatus 500 may first attempt to determine the timing of quiet periods in the candidate apparatuses by executing a synchronization algorithm that searches for periodic time instants with no transmissions. If this synchronization algorithm is successful, apparatus 500 may transmits test signals during the detected quiet periods. If this synchronization fails, apparatus 500 may transmit test signals continuously for a period of time.

If any of candidate apparatuses 604, 608, 610 and 614 requests that test signal transmission occur in some other channel than the channel used to maintain the network of the candidate apparatus, then apparatus 500 may transmit the test signal continuously for a period of time without any concern about quiet periods since no network signaling will be expected to interrupt the testing. However, candidate apparatuses may only transmit test signals on the other channel if they see it as free. Apparatus 500 still senses the other channel before transmitting. If the channel is occupied by foreign signal activity, apparatus 500 will await a silent period before transmission. In accordance with at least one embodiment of the present invention, it is also possible for the same test signal to be transmitted to all of candidate apparatuses 604, 608, 610 and 614. Upon receiving the test signal, candidate apparatuses 604, 608, 610 and 614 may provide measurement results for the received test signal to apparatus 500. The measurement results may indicate the strength of the received test signal and may be provided via the Internet.

Apparatus 500 may now have the test signal measurement reports from candidate apparatuses 604, 608, 610 and 614, and possibly also results from its own measurement of each candidate apparatus. If both of these measurements are positive (e.g., within a threshold level that may indicate that both apparatuses can reliably detect each other) a candidate apparatus may be qualified as (e.g., selected) a real neighbor. This is represented in FIG. 8 where candidate apparatuses 608 and 610 are selected as real neighbors and candidate apparatuses 604 and 614 are shaded. This selection may have been made, for example, due to the close proximity of candidate apparatuses 608 and 610 to apparatus 500, and thus, the test results may indicate more substantial test signal reception. However, in some implementations it may be enough that only one apparatus detects the other for a candidate apparatus to qualify as a real neighbor apparatus.

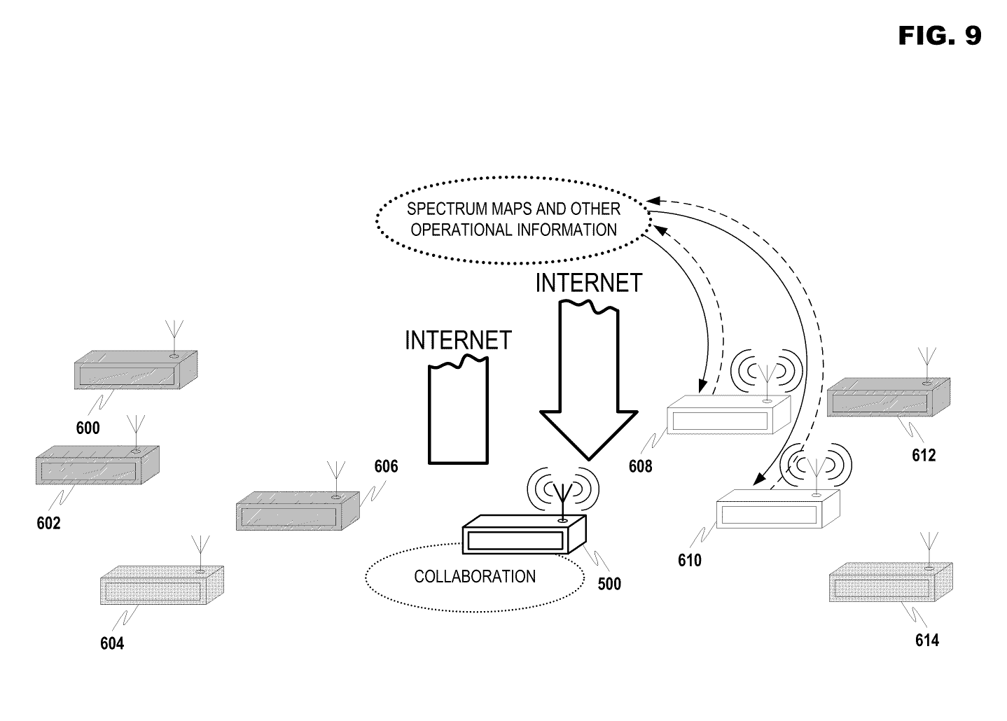

As shown in FIG. 9, this process may result in the identification of real neighbors that may be able to exchange spectrum map information for future collaboration purposes. The sharing of such operational information may occur via Internet interaction so as to avoid wireless interference, or possibly via wireless communication links arranged so that the various networks may avoid interfering with each other (e.g., per the exchanged spectrum map information). The joining of other nodes into the network of apparatus 500 may introduce other networks that are within interference range, but such occurrences may be discovered via spectrum sensing and the aforementioned server access. After initial real neighbor detection, apparatus 500 may to build a spectrum map, choose the best operation channel and provide this information to real neighbors.

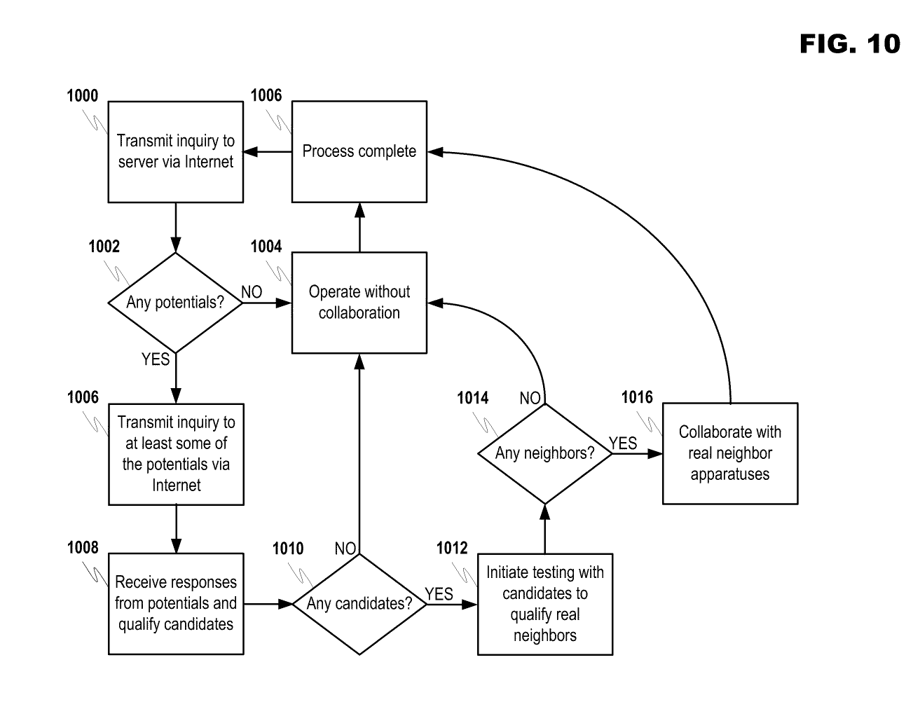

An example flowchart of a communication management process in accordance with at least one embodiment of the present invention is disclosed in FIG. 10. An apparatus may transmit an inquiry to a server via an Internet connection in step 1000. For example, the inquiry may comprise at least apparatus location information and possibly also apparatus identification and/or address information. In step 1002 a determination may be made as to whether a response has been received in the apparatus from the server, the response comprising at least a list of potential apparatuses. A response may not be received from the server if, for example, no potential apparatuses exist in the environment in which the apparatus is operating, the apparatuses that are operating in the environment will not interfere with the apparatus, the apparatuses are not network masters, etc. The process may then move to step 1004 where the apparatus may operate without collaboration. The process may be complete in step 1006 and may return to step 1000 to prepare for the next inquiry transmission.

If a response identifying one or more potential apparatuses is received in step 1002, then in step 1006 the apparatus may transmit inquiries to at least some of the potential apparatuses via an Internet connection. Inquiries may request, for example, location, communication configuration and test information. Responses to these inquiries may be received from some or all of the potential apparatuses in step 1008. A determination may then be made in step 1010 as to whether any of the responses qualify the responding potential apparatuses as candidate apparatuses. This qualification may be based on, for example, the type of communication being conducted in the potential apparatus, the distance between the apparatus and the potential apparatus, etc. If none of the apparatuses qualify as candidate apparatuses in step 1010 then the process may return to step 1004 where the operation of the apparatus may continue without collaboration. Again, the process may then terminate and return to step 1000 as set forth above.

If in step 1010 one or more candidate apparatuses are qualified (e.g., selected from the group of potential apparatuses) then in step 1012 the apparatus may initiate testing with the candidate apparatuses to determine if any of the candidate apparatuses are real neighbors. Such testing may include, for example, the transmission of test signals from the apparatus to the candidate apparatuses. Any candidate apparatus that receives a test signal may then transmit a measurement report to the apparatus via the Internet. The apparatus may then, based on the measurement report and possibly also on its own measurements, qualify candidate apparatuses as real neighbor apparatuses. If in step 1014 no real neighbors are determined to exist as a result of the testing initiated in step 1012, then the process may return to step 1004 where the apparatus may continue to operate in the environment without collaboration. Otherwise, the process may proceed to step 1015 where the apparatus may collaborate with one or more of the real neighbor apparatuses, for example, by exchanging spectrum map information. Regardless of whether the process proceeded through step 1014 or step 1016, the process may be deemed complete in step 1004 and may return to step 1006 in preparation for the next inquiry transmission to the server.

While various exemplary configurations of the present invention have been disclosed above, the present invention is not strictly limited to the previous embodiments.

For example, the present invention may include, in accordance with at least one example embodiment, an apparatus comprising means for transmitting an inquiry from an apparatus to a predefined entity via the Internet, the inquiry comprising at least information relating to the location of the apparatus, means for receiving information at the apparatus from the predefined entity via the Internet, the information at least identifying potential apparatuses in proximity to the apparatus, means for transmitting second inquiries from the apparatus to at least some of the potential apparatuses via the Internet, the second inquiries requesting location and communication configuration information associated with the potential apparatuses, means for receiving responses comprising at least location and communication configuration information at the apparatus from at least some of the potential apparatuses via the Internet, and means for selecting a group of candidate apparatuses from the potential apparatuses based on the information received in the responses.

At least one other example embodiment of the present invention may include electronic signals that cause apparatuses to transmit an inquiry from an apparatus to a predefined entity via the Internet, the inquiry comprising at least information relating to the location of the apparatus, receive information at the apparatus from the predefined entity via the Internet, the information at least identifying potential apparatuses in proximity to the apparatus, transmit second inquiries from the apparatus to at least some of the potential apparatuses via the Internet, the second inquiries requesting location and communication configuration information associated with the potential apparatuses, receive responses comprising at least location and communication configuration information at the apparatus from at least some of the potential apparatuses via the Internet, and select a group of candidate apparatuses from the potential apparatuses based on the information received in the responses.

Accordingly, it will be apparent to persons skilled in the relevant art that various changes in form and detail can be made therein without departing from the spirit and scope of the invention. The breadth and scope of the present invention should not be limited by any of the above-described example embodiments, but should be defined only in accordance with the following claims and their equivalents.

What is claimed:

1. A method, comprising:
transmitting an inquiry from an apparatus to a predefined entity via the Internet, the inquiry comprising at least information relating to the location of the apparatus;
receiving information at the apparatus from the predefined entity via the Internet, the information at least identifying potential apparatuses in proximity to the apparatus;
transmitting second inquiries from the apparatus to at least some of the potential apparatuses via the Internet, the second inquiries requesting location and communication configuration information associated with the potential apparatuses;
receiving responses comprising at least location and communication configuration information at the apparatus from at least some of the potential apparatuses via the Internet; and
selecting a group of candidate apparatuses from the potential apparatuses based on the information received in the responses.

2. The method of claim 1, further comprising initiating testing from the apparatus to the candidate apparatuses via wireless communication; and
selecting a group of real neighbor apparatuses from the group of potential apparatuses based on results from the testing received in the apparatus.

3. The method of claim 2, wherein the responses received from the at least some of the potential apparatuses via the Internet further comprise test information usable by the apparatus when initiating the testing.

4. The method of claim 3, wherein the testing comprises transmitting one or more wireless messages based on the received test information from the apparatus and receiving the results from the candidate apparatuses via the Internet.

5. The method of claim 2, further comprising collaborating with the one or more of the real neighbor apparatuses by exchanging spectrum map information via the Internet.

6. The method of claim 1, wherein the apparatus and the other apparatuses are wireless network masters controlling networks in a TV White Space operational environment.

7. The method of claim 1, wherein the information identifying potential apparatuses comprises Internet addresses corresponding to apparatuses located in close physical proximity to the apparatus or apparatuses within communication range of the apparatus, the apparatus utilizing the Internet addresses to transmit the second inquiries.

8. A computer program product comprising computer executable program code recorded on a computer readable storage medium, the computer executable program code comprising:
code configured to cause an apparatus to transmit an inquiry to a predefined entity via the Internet, the inquiry comprising at least information relating to the location of the apparatus;
code configured to cause an apparatus to receive information from the predefined entity via the Internet, the information at least identifying potential apparatuses in proximity to the apparatus;
code configured to cause an apparatus to transmit second inquiries to at least some of the potential apparatuses via the Internet, the second inquiries requesting location and communication configuration information associated with the potential apparatuses;
code configured to cause an apparatus to receive responses comprising at least location and communication configuration information at the apparatus from at least some of the potential apparatuses via the Internet; and
code configured to cause an apparatus to select a group of candidate apparatuses from the potential apparatuses based on the information received in the responses.

9. The computer program product of claim 8, further comprising code configured to cause an apparatus to initiate testing from the apparatus to the candidate apparatuses via wireless communication; and
code configured to cause an apparatus to select a group of real neighbor apparatuses from the group of potential apparatuses based on results from the testing received in the apparatus.

10. The computer program product of claim 9, wherein the responses received from the at least some of the potential apparatuses via the Internet further comprise test information usable by the apparatus when initiating the testing.

11. The computer program product of claim 10, wherein the testing comprises transmitting one or more wireless messages based on the received test information from the apparatus and receiving the results from the candidate apparatuses via the Internet.

12. The computer program product of claim 9, further comprising code configured to cause an apparatus to collaborate with the one or more of the real neighbor apparatuses by exchanging spectrum map information via the Internet.

13. The computer program product of claim 8, wherein the apparatus and the other apparatuses are wireless network masters controlling networks in a TV White Space operational environment.

14. The computer program product of claim 8, wherein the information identifying potential apparatuses comprises Internet addresses corresponding to apparatuses located in close physical proximity to the apparatus or apparatuses within communication range of the apparatus, the apparatus utilizing the Internet addresses to transmit the second inquiries.

15. An apparatus, comprising:
at least one processor; and
at least one memory including executable instructions, the at least one memory and the executable instructions being configured to, in cooperation with the at least one processor, cause the apparatus to perform at least the following:
transmit an inquiry to a predefined entity via the Internet, the inquiry comprising at least information relating to the location of the apparatus;
receive information from the predefined entity via the Internet, the information at least identifying potential apparatuses in proximity to the apparatus;
transmit second inquiries to at least some of the potential apparatuses via the Internet, the second inquiries requesting location and communication configuration information associated with the potential apparatuses;
receive responses comprising at least location and communication configuration information at the apparatus from at least some of the potential apparatuses via the Internet; and
select a group of candidate apparatuses from the potential apparatuses based on the information received in the responses.

16. The apparatus of claim 15, wherein the apparatus is further caused to initiate testing from the apparatus to the candidate apparatuses via wireless communication; and
select a group of real neighbor apparatuses from the group of potential apparatuses based on results from the testing received in the apparatus.

17. The apparatus of claim 16, wherein the responses received from the at least some of the potential apparatuses via the Internet further comprise test information usable by the apparatus when initiating the testing.

18. The apparatus of claim 17, wherein the testing comprises transmitting one or more wireless messages based on the received test information from the apparatus and receiving the results from the candidate apparatuses via the Internet.

19. The apparatus of claim 16, wherein the apparatus is further caused to collaborate with the one or more of the real neighbor apparatuses by exchanging spectrum map information via the Internet.

20. The apparatus of claim 15, wherein the apparatus and the other apparatuses are wireless network masters controlling networks in a TV White Space operational environment.

21. The apparatus of claim 15, wherein the information identifying potential apparatuses comprises Internet addresses corresponding to apparatuses located in close physical proximity to the apparatus or apparatuses within communication range of the apparatus, the apparatus utilizing the Internet addresses to transmit the second inquiries.

22. A system, comprising:
a master apparatus;
a predefined entity; and
potential master apparatuses located proximate to the master apparatus;
the apparatus transmitting an inquiry to the predefined entity via the Internet, the inquiry comprising at least information related to the location of the apparatus, and receiving information from the predefined entity via the Internet, the information at least identifying the potential apparatuses;
the apparatus further transmitting second inquiries to at least some of the potential apparatuses via the Internet, the second inquiries requesting location and communication configuration information and receiving responses from at least some of the potential apparatuses via the Internet; and
the apparatus further selecting a group of candidate apparatuses from the potential apparatuses based on the information received in the responses.
